(19) United States
(12) Patent Application Publication
(10) Pub. No.: US 2025/0334959 A1
(43) Pub. Date: Oct. 30, 2025

(54) Anomalous Event Detection System with Sparse, Event-Driven Sensor Data

(71) Applicant: The United States of America, as represented by the Secretary of the Navy, Arlington, VA (US)

(72) Inventors: Dean-yue Lee, San Diego, CA (US); Jamal Rorie, San Diego, CA (US)

(21) Appl. No.: 18/646,227

(22) Filed: Apr. 25, 2024

(51) Int. Cl. G05B 23/02; G05B 19/418

(52) U.S. Cl. CPC G05B 23/0218; G05B 19/4184

(57) ABSTRACT

A machine anomaly detection method comprising: collecting sparse, event-driven, time series data from one or more physical sensors; inputting the sparse, event-driven, time series data into a heterogeneous ensemble of at least two disparate and independent anomaly detection algorithms; receiving an output from each of the disparate and independent anomaly detection algorithms, wherein each output comprises a score and an uncertainty associated with detection of an anomaly; and combining, with a processor, the outputs into a unified output that comprises an overall score and an overall uncertainty associated with the anomaly.

### FEDERALLY-SPONSORED RESEARCH AND DEVELOPMENT

The United States Government has ownership rights in the invention claimed herein. Licensing and technical inquiries may be directed to the Office of Research and Technical Applications, Naval Information Warfare Center Pacific, Code 72110, San Diego, CA, 92152; voice (619) 553-5118; NIWC_Pacific_T2@us.navy.mil. Reference Navy Case Number 211559.

### BACKGROUND OF THE INVENTION

Due to the data storage and throughput constraints in some scenarios, current methods of monitoring system health to perform condition-based maintenance involve using sensors that collect data in the form of sparse, event-driven time series. That is, the collected data may be sampled at low frequencies, and the recording of data is triggered only when pre-defined events take place. Thus, current high-frequency signals processing methods may be inappropriate to extract actionable insights from this type of sensor data. There is a need for an improved method for detecting anomalies in monitored equipment from sparse, event-driven sensor data.

### SUMMARY

Disclosed herein is an anomaly detection method comprising the following steps. One step provides for collecting sparse, event-driven, time series data from one or more physical sensors. Another step provides for inputting the sparse, event-driven, time series data into a heterogeneous ensemble of at least two disparate and independent anomaly detection algorithms. Another step provides for receiving an output from each of the disparate and independent anomaly detection algorithms. Each output comprises a score and an uncertainty associated with detection of an anomaly. Another step provides for combining, with a processor, the outputs into a unified output that comprises an overall score and an overall uncertainty associated with the anomaly.

Another embodiment of the anomaly detection method is described herein as comprising the following steps. A first step provides for collecting sparse, event-driven, time series data from one or more physical sensors connected to a machine. Another step provides for inputting the sparse, event-driven, time series data into a heterogeneous ensemble of at least two disparate and independent anomaly detection algorithms. Another step provides for receiving an output from each of the disparate and independent anomaly detection algorithms. Each output comprises a score and an uncertainty associated with detection of an anomaly. Another step provides for combining, with a processor, the outputs into a unified output that comprises an overall score and an overall uncertainty associated with the anomaly so as to provide a prognosis of potential issues with the machine so that appropriate maintenance can be performed to avoid catastrophic failures of the machine.

### BRIEF DESCRIPTION OF THE DRAWINGS

Throughout the several views, like elements are referenced using like references. The elements in the figures are not drawn to scale and some dimensions are exaggerated for clarity.

FIG. 1 is a flowchart of an anomaly detection method.

FIG. 2 is a block diagram.

FIG. 3 is a plot of data.

FIG. 4 is a scatter plot of recorded data.

FIG. 5 is a bar chart.

FIG. 6 is a plot of a derived engine attribute.

FIGS. 7A, 7B, and 7C are graphs of data.

FIGS. 8A, 8B, 8C, 8D, 8E, and 8F are graphs of likelihood scores for different example anomaly detection algorithms in different configurations.

### DETAILED DESCRIPTION OF EMBODIMENTS

The disclosed methods below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

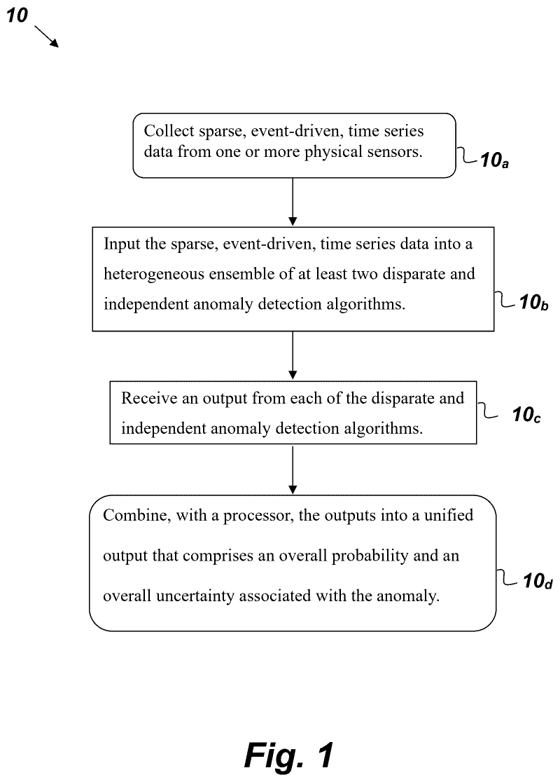

FIG. 1 is a flowchart of an anomaly detection method 10 that comprises, consists of, or consists essentially of the following steps. A first step 10a provides for collecting sparse, event-driven, time series data from one or more physical sensors. Another step 10b provides for inputting the sparse, event-driven, time series data into a heterogeneous ensemble of at least two disparate and independent anomaly detection algorithms. Having three or more disparate and independent anomaly detections algorithms in the heterogeneous ensemble is considered to be preferable. Another step 10c provides for receiving an output from each of the disparate and independent anomaly detection algorithms. Each output comprises a score and an uncertainty associated with detection of an anomaly. Each output may comprise a time index and step/window width as well, which is described in greater detail below. Another step 10a provides for combining, with a processor, the outputs into a unified output that comprises an overall score and an overall uncertainty associated with the anomaly. Method 10 may use multiple anomaly detection algorithms to detect multiple different anomalies. Depending on the outputs of the various anomaly detection algorithms, method 10 may ignore a given output from a given algorithm.

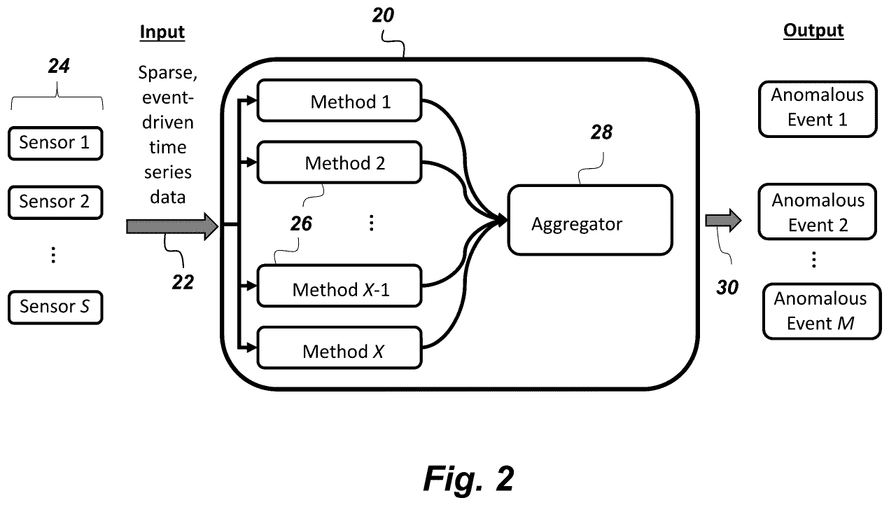

FIG. 2 is a block diagram illustrating an embodiment of a system 20 that may be used to implement the anomaly detection method 10. System 20 is configured to receive sparse, event-driven time series data input 22 from a plurality of sensors 24. A heterogeneous ensemble of at least two disparate and independent anomaly detection algorithms 26 are configured to each generate an anomaly prediction output 27 for a given anomaly. Each anomaly detection algorithm 26 may be configured to receive the sensor data 22 generated by one or more of the sensors 24. In some embodiments the anomaly detection algorithms 26 may all share all the sensor data 22 from all the sensors 24. In other embodiments, each anomaly detection algorithm 26 corresponds to one or more given sensor(s) 24, and the associated sensor data 22 from the one or more given sensor(s) 24 is/are not shared with the other anomaly detection algorithms 26. Each anomaly prediction output 27 from each of the anomaly detection algorithms 26 comprises a score and an uncertainty associated with detection of the given anomaly. System 20 uses an aggregator 28 to combine the outputs from each of the disparate and independent anomaly detection algorithms 26 into a unified output 30 that comprises an overall score and an overall uncertainty associated with the given anomaly. The anomaly detection method 10 may be repeated to detect M different anomalous events.

System 20 may be configured to take the sparse, event-driven sensor data 22 and produce outputs 30 that indicate when and where anomalous events may have occurred, as well as the scores and uncertainties associated with the detections of the anomalous events. This information may be used to help equipment maintainers act upon previously undetectable fault indicators and more accurately anticipate conditions leading to equipment failure, thus keep the equipment operating longer. System 20 may comprise an arbitrary number X of disparate anomalous detection algorithms 26, each of which detects anomalous events independent of the others. System 20 produces a single set of scores and uncertainties (i.e., unified output 30) for each detected anomalous event. Anomaly detection method 10 may be used as a decision aid for engineers and maintainers to take preventive maintenance actions and optimize asset readiness.

Each of the disparate anomaly detection algorithms 26 may be configured to evaluate different aspects of the input signal 22 for anomalies. The various anomaly detection algorithms 26 must conform to the following requirements: 1) each anomaly detection algorithm 26 must accept a time series data stream as input, and 2) the outputs of each anomaly detection algorithm 26 must be the detections of anomalous events and their associated scores and uncertainties. With these two requirements imposed on each anomaly detection algorithm 26, the aggregator 28, which may be a meta-learner, aggregates the output scores and uncertainties from the disparate algorithms into the unified output 30 of detected anomalous events and their associated scores and uncertainties. Anomaly detection method 10 does not rely on a single anomaly detection method, which may have built-in bias for specific data sets, but rather leverages an arbitrary number X of disparate anomaly detection methods 26, such that any biases inherent in any of the anomaly detection methods are smoothed out through the ensembling of the anomaly detection methods.

Method 10 and system 20 allow for the addition and removal of anomaly detection methods to create tailored anomaly detection solutions for any equipment installation (e.g., pumps, motors, engines, bearings, ship, aircraft, industrial plant, automobile, etc.). For example, a specific anomaly detection algorithm may be added to the heterogeneous ensemble when the overall score or overall uncertainty associated with a given anomaly exceeds a confidence value, which, for example, may be set by a user or found empirically. Likewise, a given anomaly detection algorithm may be removed from the heterogeneous ensemble if the given anomaly detection algorithm's output has a value below the confidence value. Anomaly detection method 10 enables maintainers to make informed decisions about which components/parts of a particular machine may need to be replaced/repaired/serviced prior to catastrophic failure of that particular machine. Furthermore, method 10 may be employed in a meteorology scenario where the anomaly one is trying to detect is a weather condition and the sensor data comes from a variety of different sensors (e.g., wind speed, temperature, pressure, humidity, etc.).

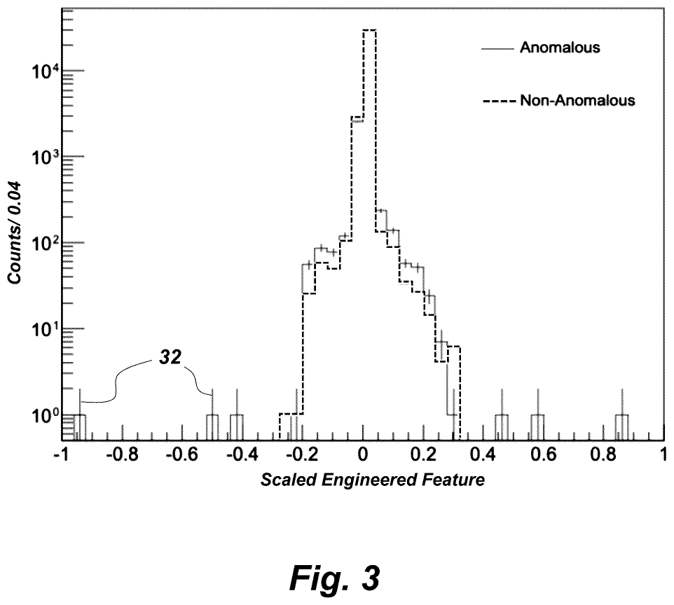

FIG. 3 is a plot of data showing a comparison of histograms of a physics-inspired feature for two different specimens of similar equipment: one specimen that has a recorded anomalous event (solid line), another that does not (dotted line). Outliers 32 are present in the histogram of the anomalous specimen that do not appear for the non-anomalous specimen. The following is an example embodiment of the anomaly detection method 10 with respect to a specific type of engine installed in several different assets (also referred to as platforms herein). Sparse, event-driven time series data was obtained from a first set of sensors connected to assets with known engine conditions and from a second set of sensors connected to assets without any known engine issues. The anomaly detection method 10 provides prognosis of potential issues so that appropriate maintenance can be performed to avoid catastrophic failures. For example, performing the steps of method 10 with respect to data from a particular platform, a component of that particular platform may be repaired or replaced based on the overall probability and the overall uncertainty associated with a detected anomaly before the component fails completely-thus avoiding catastrophic failure.

The following is a description of an example of a physics-based anomaly detection algorithm, also referred to herein as the physics-based method, that leverages the observations of a platform's engine kinematics. In one embodiment, the physics-based method may take the input sensor data and calculate the rate of change of the sensor attribute with respect to time via numerical differentiation. The differentiation may be implemented using temporally adjacent points to create as near an instantaneous derivative estimation as possible. Using a set time window width is also an acceptable technique if the data sampling period is irregular. The rate of change for both the defective (those with anomalous events) and non-defective specimens may be recorded, and fit to a logistic regressor, from which a prediction score and uncertainty can be quantified for a test specimen. In this example scenario, some of the platform's sensors record data could be used to calculate other aspects of the engine's dynamics. Formalisms motivated by physical systems may be applied to the sensor data collected from each platform. By studying the dynamic nature of the data measured by engine sensors in the same way that one would study the dynamic nature of a physical system, we derive an engineered feature that is a reliable indicator of a past anomaly. In one implementation, the sensor data was divided into two groups: one for platforms that had an anomalous event that was recorded by (a) human observer(s), another for platforms that were similar (e.g. similar location, administrative group, activity, et cetera) that had no record of the anomalous event. For each platform in the anomaly group, there were multiple similar platforms in the non-anomaly group for comparison. Data for three months leading up to and including the date of the anomalous events were selected for each of the platforms in the anomalous group. The corresponding date range was selected for each of the non-anomalous platforms associated with the anomalous platform. The features were engineered for both data sets, and the value of the engineered features were plotted as a histogram for all platforms. (See FIG. 3 as an example) The anomalous and non-anomalous specimens were selected and grouped into sets as to ensure as much similarity as possible between the anomalous and non-anomalous specimens being compared. Among the characteristics compared were their profiles of location, usage, personnel, time period selected (as explained previously), et. cetera. The comparative histograms were examined for systematic differences in distributions between the anomalous and non-anomalous data sets. One difference that was immediately observed was presence of outliers 32 in some of the anomalous engineered feature distributions compared to non-anomalous distributions. An example of such a distribution comparison is presented in FIG. 3. One specimen had at least one recorded anomalous event, the other had none. The difference was clear enough that a human investigator can infer a reasonable threshold value for some engineered features. Through this process, the value of one engineered feature was found to be strongly correlated to whether there was an anomalous incident in a platform's past.

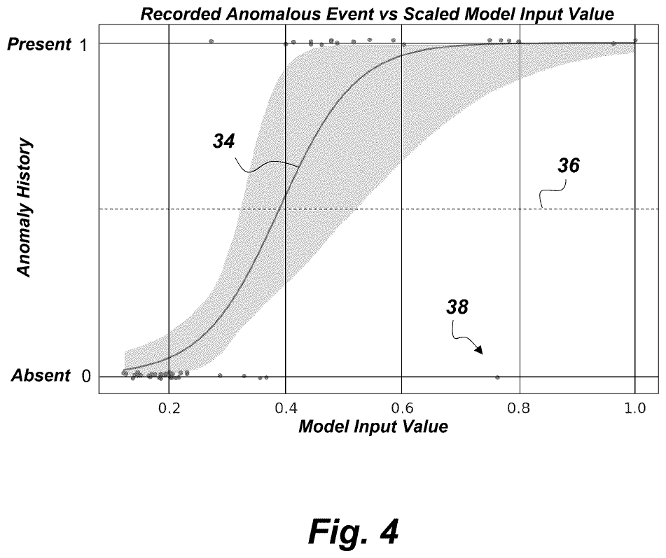

FIG. 4 is a scatter plot of recorded data showing a spike in the afore-mentioned engineered feature that rose above a threshold value for nearly all platforms that had a recorded anomalous event. FIG. 4 shows the distribution of the model input feature for a platform separated by whether the individual unit was recorded as experiencing the anomalous event. Measurements from platforms that with (a) recorded anomalous event(s) are plotted at y=1. Measurements from platforms with no recorded anomalous event are plotted at y=0. A sigmoid function 34 fitting the data is displayed. The horizontal dashed line 36 is set at y=0.5 and serves as a likelihood threshold.

The x-axis of FIG. 4 is the scaled value of the engineered feature. A data point is recorded if either a) the value of the engineered feature is above an empirically determined threshold (i.e., threshold line 34) or b) that data point is the highest value of the engineered feature for that platform regardless of threshold. The data points are sorted along the y-axis by their source: data points that come from a platform with a recorded anomalous event are plotted at the top (y=1); those that come from a platform with no recorded anomalous event are plotted at the bottom (y=0). The value of the distribution of this feature is consistently higher for platforms that have a recorded anomalous event than for those that do not. The sigmoid function 34 illustrates the output of a logistic regressor fit to this data. The likelihood threshold line 36 illustrates a 50% confidence threshold, which can be used to illustrate predictions of the logistic regressor with the default confidence threshold. Assuming all anomalous events are captured and correctly recorded, this logistic regressor (and the threshold method) would have an F1 score of 0.94 on this particular data set.

The physics-based anomaly detection algorithm is data-driven and thus yields several important benefits. The most important benefit is that it is possible that the physics-based anomaly detection algorithm may detect anomalous events that human observers did not recognize or record. An example of this is the non-anomalous platform with the high feature value shown in FIG. 4 as point 38. Since the anomaly recording by humans is heavily dependent on subjective experience, it is possible that the human operators and subject matter experts (SME) did not recognize the anomalous event at point 38. It is thus reasonable to apply further scrutiny to this particular platform's performance and maintenance history. Additionally, this physics-based anomaly detection algorithm technique can also be used to corroborate the recorded date of an anomalous event and further provide a more precise timestamp than what is currently present in maintainer logs. This combination of possibly identifying previously undiscovered anomalous platforms and high precision identification of the timing of anomalous events may yield more relevant data that can be used to develop root cause analysis.

Another suitable example of an anomaly detection algorithm that may be used with method 10 is a Symbolic Aggregation approXimation (SAX) algorithm such as is described in the paper “HOT SAX: Efficiently Finding the most unusual time series subsequence” in the 5th IEEE International Conference on Data Mining (ICDM), pages 226-233, 11 2005, by Eamonn Keogh, Jessica Lin, and Ada Fu, which paper is incorporated by reference herein. The SAX algorithm is further described in the paper “Experiencing sax: a novel symbolic representation of time series” in Data Mining and knowledge discovery, 15:107-144, 2007 by Jessica Lin, Eamonn Keogh, Li Wei, and Stefano Lonardi, which paper is also incorporated by reference herein. The SAX method converts the input sensor data into a series of symbolic representations. The symbolic representations are compared against each other in a pairwise fashion, where the anomalous events would be represented by symbols which are most different from the rest of the sensor input. The scoring of the comparisons is done by standard approaches such as the Isolation Forest. The SAX algorithm is composed of two steps: a piece-wise aggregate approximation (PAA) transformation is first applied on the input time series data, then the PAA values are translated into letters to form word representations of the time series data. The PAA algorithm starts by creating a sliding window of size w across the input time series, which have already been standardized. Within each window, m segments are created, and the mean values are computed for each segment. In the translation step, an alphabet size of a is determined a priori, and a bins are created under the density curve of N(0; 1), so that the areas in each bin are equal. Each bin is then associated with a letter in the a-sized alphabet. The mean values computed in the PAA step are mapped to a letter, based on the bin that the values fall into.

The SAX algorithm was applied to the afore-mentioned engine data. First the engine data was standardized as it is required as an input into the SAX algorithm. The engine data was standardized per asset, as the standardization of data across different assets may mask the characteristics of an anomaly for a particular asset. Sliding windows were created for each set of engine data. A time threshold of t was selected, so that if the time difference between consecutive samples collected at times tᵢ, tᵢ₊₁ in the time series exceeded t, then the sliding window stopped at tᵢ, and a new set of sliding windows would start at tᵢ₊₁. Thus, every window generated had consecutive samples with time gaps less than t. The SAX algorithm was applied to each window so that a sequence of words were generated. The words which were closest in time to the known anomalous events were labeled as the event words, and all the others were labeled as non-event words. The distributions of the event words were examined against the non-event words to identify unique event words that were used as indicators for the anomalous events.

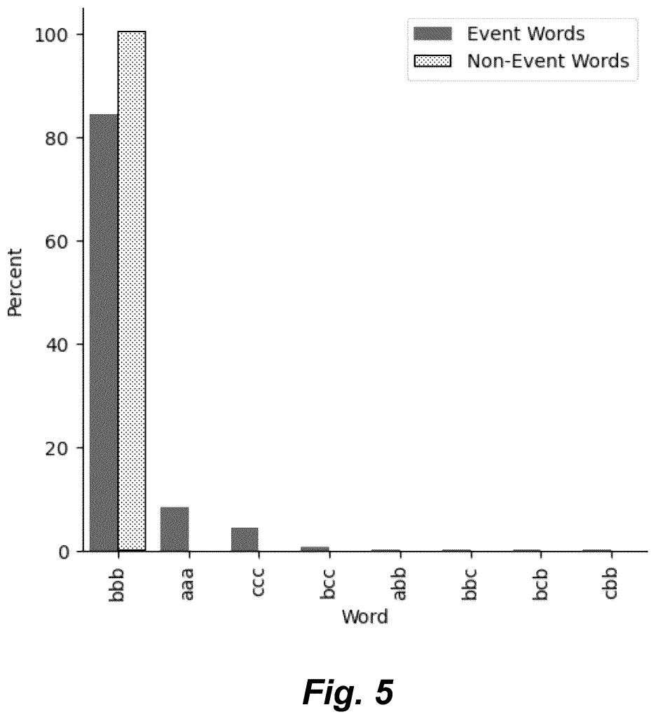

FIG. 5 is a bar chart showing the distribution of event vs. non-event SAX words for a particular asset. The SAX algorithm was applied on a derived engine attribute through some duration of time until a significant engine event developed. Note the large number of unique SAX words which may be indicative of the engine event.

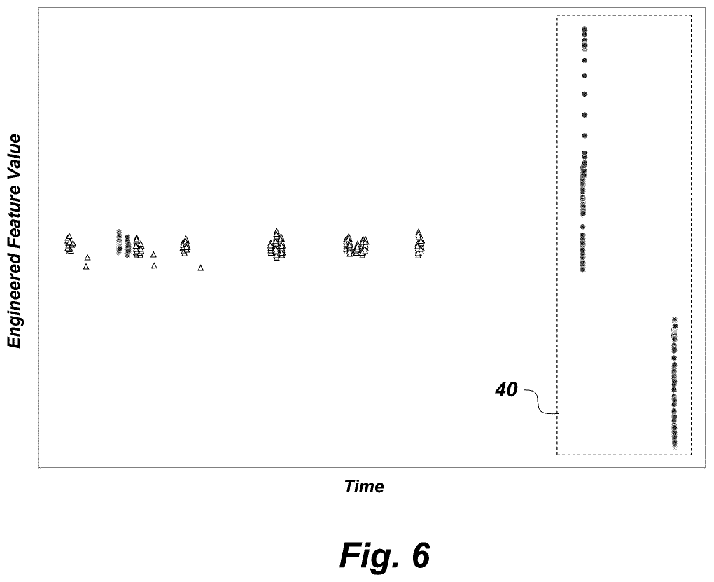

FIG. 6 is a plot of the derived engine attribute, or measured engineered feature values over time for a given engine. The round dots indicate the plotted engine values that contain event SAX words, and the triangle groupings indicate the plotted engine values that contain non-event SAX words. The last two round-dot groups of values (bounded by box 40 in FIG. 6) represent when the significant engine issues developed, as corroborated by maintenance data (e.g., maintainers' observations outside of the time-series data that was inputted to the SAX algorithm). Note that the SAX algorithm was able to pick out anomalies prior to the actual engine events. This feature of the SAX algorithm is particularly useful for maintainers who may want to perform preventive actions, so that the asset continues to operate without interruption. The application of SAX on some assets with known engine issues reveal that the SAX algorithm, with minimal hyper-parameter tuning, was able to correctly identify the engine anomaly for over 80% of the assets. Closer inspections of the remaining 20% of the assets reveal that the engine anomaly may have occurred much earlier than the maintenance data indicated. Thus, even with minimal tuning, the SAX algorithm is able to detect anomalies successfully with sparse, event-driven sensor data.

The physics-based anomaly detection algorithm and the SAX algorithm outlined above may be applied across a wide variety of domains. For the physics-based approach, the methodologies used in the study of dynamic properties of physical systems may be adapted to sensor data from the platform under study. For the physics-based anomaly detection algorithm, it is preferable that there be accurate and precise sampling from the sensors, precise recording of the sampling times, and sufficient sample size and frequency. When this is the case, the physics-based anomaly detection algorithm may be applied to sensor data of platform properties that would not normally be considered in the detection of anomalous events or would only be considered in terms of thresholds crossed. The SAX algorithm was originally created for high frequency data, but it is possible to apply the SAX algorithm on sparse, event-driven time series data for anomaly detection. One benefit of the SAX algorithm is that it leverages the PAA, which smooths noisy data by computing the means of predefined intervals. When used as an anomaly detection algorithm in anomaly detection method 10, the smoothing procedure of the SAX algorithm effectively creates a representation for intervals which may be extremely sparse. Thus, an analysis of the input signal is made possible through the SAX algorithm that may not have been possible with other signals processing methodologies.

In some scenarios, the physics-based algorithm was able to detect events or system states that are precursors to an anomalous event. While there is great utility in discovering anomalous events with objective, data-driven methods; the physics-based algorithm has some drawbacks. For example, in the previous experiment described above, one anomalous specimen was not detected with this technique. The SAX algorithm is sensitive to the hyper-parameter values. In our experiment, since the engine events were catastrophic failures, the engine attribute values usually deviated enough from “normal” values that the SAX words were unique. But to find precursor events that lead up to the catastrophic events, the window and alphabet sizes require careful tuning. It is also desirable that these hyper-parameter values should also incorporate feedback from stakeholders, who must prioritize between false positives and false negatives. A high false positive tolerance means the SAX algorithm is tuned to detect minute changes in the data, and may cause unnecessary inspection events. Whereas a high false negative tolerance means anomalous events may not be detected until it is too late.

The physics-based anomaly detection algorithm and the SAX algorithm are just two suitable examples of anomaly detection algorithms 26 that may be used with method 10. Different aspects of the sparse, time series data may be used by the various anomaly detection algorithms 26. It is possible to craft features by focusing only particular segments of the time series data to highlight specific characteristics of the data. As the ensemble of anomaly detection algorithms increases in numbers of algorithms, it is preferable to create a unified anomalous event detection mechanism such as the aggregator 28, which can be used to aggregate the engineered features into one cohesive output. In one embodiment, the aggregator 28 may be configured to use machine learning to create the unified output 30. A machine learning model may be created per anomaly detection algorithm 26 for embodiments of the method 10 where the anomaly detection algorithms rely on different parts of the input data. In that way, an ensemble of all the anomaly detection algorithms may be created, and the predictions may be aggregated in a reasonable manner, e.g. averaged prediction probabilities.

The parameters of the individual models may be optimized independently of the others. For example, if the ensemble of anomaly detection algorithms 26 includes a SAX method and a kinematics-based method, the selections of window and alphabet sizes with respect to the SAX feature extraction do not impact the parameters of the kinematics-based technique. The uncertainties of each feature extraction method may be aggregated into a single prediction interval through the ensembling in a natural way. As discussed above, method 10 can accommodate an arbitrary number X of anomaly detection algorithms, thereby leveraging all the strengths from them. The probabilities and uncertainties that are generated from the ensemble of anomaly detection algorithms allows a user to adjust a confidence threshold and system 20 may be configured to show to the user only those results which meet that threshold.

Another example of a suitable anomaly detection algorithm 26 is a topological data analysis (TDA) method. The TDA method converts the input sensor data into a series of topological quantities. These quantities may be compared against each other in a pairwise fashion, where the anomalous events would be represented by symbols which are most different from the rest of the sensor input. The scoring of the comparisons may be done with an unsupervised decision-tree-based algorithm such as the Isolation Forest.

The unified output may be generated via conformal prediction as follows. Given a particular input of time series data, there are multiple anomaly detection algorithms that can find anomalous regions in the input data. Every algorithm has different strengths and weaknesses. The anomalous regions detected by each anomaly detection algorithm may be slightly different that those detected by other algorithms. Method 10 harnesses the power of various anomaly detection algorithms and combines their outputs into a single unified output, with an overall uncertainty or confidence determination for a given detected anomaly.

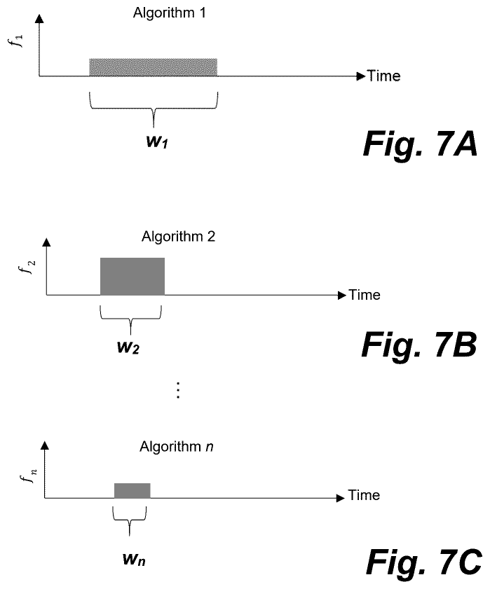

FIGS. 7A, 7B, and 7C are graphs showing a likelihood score f of anomaly detection over time for several example anomaly detection algorithms. Each graph portrays a detection window of different sizes The likelihood score f has a value between 0 and 1. The window size w represents an inherent “uncertainty” of the detection: bigger window means less certainty. A conformal score s for a given anomaly detection algorithm may be defined as:

$$s = 1 - ( ( 1 / w ) * f ) \qquad Eq . 1$$

A conformal score s_{ensemble} of the unified output (i.e., ensembled detection of an anomaly) may be defined by Equation 2 as follows:

$${s}_{ensemble} = \frac{1}{n} {\sum }_{i = 1}^{n} {s}_{i} \qquad Eq . 2$$

where i is a summation index and n represents the number of anomaly detection algorithms, and sᵢ represents the conformal score of algorithm i.

To quantify the uncertainty of any given anomaly detection algorithm (one may use a conformal prediction process, such as is disclosed in the paper, “A gentle introduction to conformal prediction and distribution-free uncertainty quantification,” by A. Anastasios and S. Bates, which paper is incorporated by reference herein.

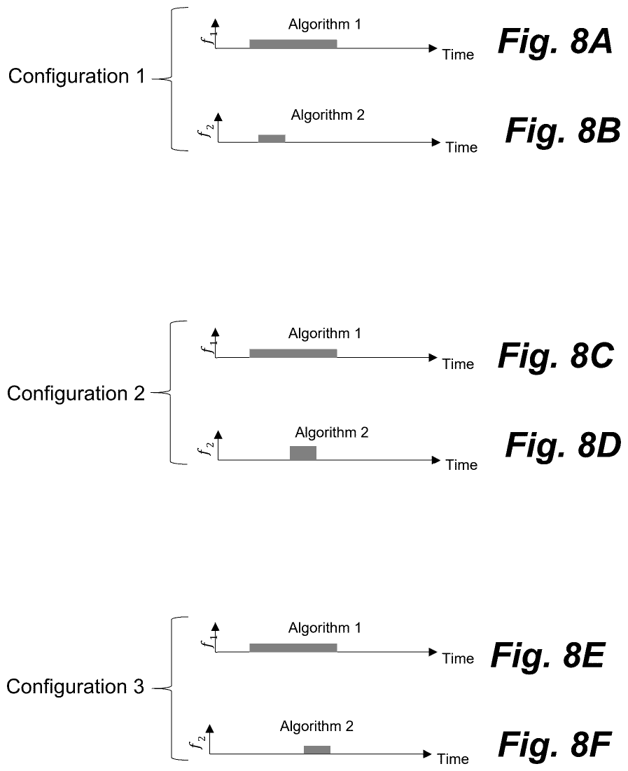

FIGS. 8A, 8B, 8C, 8D, 8E, and 8F are graphs of likelihood scores for different example anomaly detection algorithms in different configurations. FIGS. 8A and 8B show a first algorithm and a second algorithm respectively in a first configuration. FIGS. 8C and 8D show the first algorithm and the second algorithm respectively in a second configuration. FIGS. 8E and 8F show the first algorithm and the second algorithm respectively in a third configuration. With respect to the conformal prediction for the unified output of the ensemble of anomaly detection algorithms, one may assume window sizes wᵢ are fixed for algorithm i, but wᵢ≠wⱼ for i≠j. Also, let π(i) index the algorithms by their window size, such that π(1)≤π(2)≤ . . . ≤π(n). For a window of size w_{(π(n))}, one may calculate s_{ensemble} values within that window for all algorithms and their appropriate window configurations. In the examples shown in FIGS. 8A-8F, the first algorithm has the largest window size wₘₐₓ, and there are three configurations for the second algorithm within wₘₐₓ. Accordingly, three ensemble scores may be calculated. If there are overlapping sliding windows for the second algorithm, there would be more than three configurations.

Continuing with the conformal prediction for the unified output of the ensemble of anomaly detection algorithms, a first approach may involve the first step of creating a calibration set with clean data as discussed above. Another step may provide for creating a sliding window with size wₘₐₓ by computing the ensemble conformal scores as described above. For each window, a max, min, and mean value of the conformal scores may be kept. The conformal prediction may be accomplished by creating a sliding window with size wₘₐₓ and Computing the Ensemble conformal scores as described above. Then, one may compute the max/min/mean values of the conformal scores for each window, from which the presence of anomalies may be determined.

A second approach to generating the conformal prediction for the unified output of the ensemble of anomaly detection algorithms, involves fixing w so that the window sizes are the same for all algorithms. Then, sliding windows of size w may be created for the calibration set, where only one s_{ensemble} value is created for each window. Next, one may proceed with outlier detection as described above.

From the above description of the anomaly detection method 10, it is manifest that various techniques may be used for implementing the concepts of method 10 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that the anomaly detection method 10 is not limited to the particular embodiments described herein, but is capable of many embodiments without departing from the scope of the claims.

We claim:

1. A machine anomaly detection method comprising:
collecting sparse, event-driven, time series data from one or more physical sensors;
inputting the sparse, event-driven, time series data into a heterogeneous ensemble of at least two disparate and independent anomaly detection algorithms;
receiving an output from each of the disparate and independent anomaly detection algorithms, wherein each output comprises a score and an uncertainty associated with detection of an anomaly; and
combining, with a processor, the outputs into a unified output that comprises an overall score and an overall uncertainty associated with the anomaly.

2. The anomaly detection method of claim 1, further comprising:
adjusting a confidence threshold; and
displaying to a user only anomaly detection results that meet the threshold.

3. The anomaly detection method of claim 2, wherein each of the disparate and independent anomaly detection algorithms is configured to evaluate different aspects of the sparse, event-driven, time series data to detect the anomaly.

4. The anomaly detection method of claim 3, wherein the combining step is performed by using a processor to create an ensemble which aggregates the output probabilities and uncertainties from the disparate and independent anomaly detection algorithms into the unified output.

5. The anomaly detection method of claim 4, wherein each of the disparate and independent anomaly detection algorithms must accept a time series data stream as an input.

6. The anomaly detection method of claim 5, further comprising adding a specific anomaly detection algorithm to the heterogeneous ensemble when the overall score or overall uncertainty associated with the anomaly exceeds a confidence value range.

7. The anomaly detection method of claim 6, further comprising removing a given anomaly detection algorithm from the heterogeneous ensemble if the given anomaly detection algorithm's output has a value below the confidence value range.

8. The anomaly detection method of claim 5, further comprising removing a given anomaly detection algorithm from the heterogeneous ensemble if patterns are found in the sparse, event-driven, time series data that are known to result in false anomaly detections.

9. The anomaly detection method of claim 5, wherein the heterogeneous ensemble includes a physics-based algorithm, a machine learning algorithm, and a TDA algorithm.

10. The anomaly detection method of claim 9, wherein the anomaly is a precursor of a physical component failure.

11. The anomaly detection method of claim 10, further comprising considering a platform to be monitored when selecting the disparate and independent anomaly detection algorithms that make up the heterogeneous ensemble.

12. The anomaly detection method of claim 11 further comprising replacing a component on the platform based on the overall score and the overall uncertainty associated with the detected anomaly before the component fails completely.

13. The anomaly detection method of claim 1, wherein the step of combining, with a processor, the outputs into a unified output that comprises an overall score and an overall uncertainty associated with the anomaly is performed through a conformal prediction process.

14. An anomaly detection method comprising:
collecting sparse, event-driven, time series data from one or more physical sensors connected to a machine;
inputting the sparse, event-driven, time series data into a heterogeneous ensemble of at least two disparate and independent anomaly detection algorithms;
receiving an output from each of the disparate and independent anomaly detection algorithms, wherein each output comprises a score and an uncertainty associated with detection of an anomaly; and
combining, with a processor, the outputs into a unified output that comprises an overall score and an overall uncertainty associated with the anomaly so as to provide a prognosis of potential issues with the machine so that appropriate maintenance can be performed to avoid catastrophic failures of the machine.

15. The method of claim 14, wherein the machine in an engine.

16. The method of claim 15, wherein the ensemble of disparate and independent anomaly detection algorithms includes a kinematics-based algorithm that comprises the following steps:
comparing an anomalous data set (consisting of characteristic values from a group of similar machines that experienced a known anomalous event) and a non-anomalous data set (consisting of characteristic values from a non-anomaly group of similar machines) by plotting the anomalous and non-anomalous data sets on a histogram;
identifying systematic differences in distributions between the anomalous and non-anomalous data sets; and
establishing a threshold value of one or more characteristic values that correlates to an anomalous event.

17. The method of claim 16, further comprising adjusting the threshold value based on a type of machine being monitored.

18. The method of claim 17, wherein the anomalous data set is contains data gathered for a time period before the known anomalous event.

19. The method of claim 18, wherein the time period is three months up to and including a date of the known anomalous event.

20. The method of claim 18, wherein the ensemble of disparate and independent anomaly detection algorithms includes a symbolic aggregation approximation (SAX) method.
